(19) United States
(12) Patent Application Publication
(10) Pub. No.: US 2010/0134404 A1
(43) Pub. Date: Jun. 3, 2010

(54) Video Display Apparatus and Video Display Method

(75) Inventors: Masaki Tsuchida, Hamura-shi (JP); Ken Ito, Yamato-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/485,709

(22) Filed: Jun. 16, 2009

(30) Foreign Application Priority Data
Nov. 28, 2008 (JP) 2008-305209

(51) Int. Cl. G09G 3/36; H04N 3/14

(52) U.S. Cl. 345/102; 348/790; 348/E03.016; 345/690

(57) ABSTRACT

According to one embodiment, a video display apparatus includes a display module, a light source device, a video signal input module, a virtual illumination value calculator, a light source illumination value calculator, and a light source controller. The light source device is divided into light source areas in a honeycomb shape and provided with light sources to light up the light source areas. The virtual illumination value calculator calculates an area illumination value indicating the brightness of light source areas to light up based on a video signal received by the video signal input module. The light source illumination value calculator calculates a light source illumination value to light up the light sources based on the area illumination value. The light source controller lights up the light sources synchronously with the video signal being displayed on the display module based on the light source illumination value.

### CROSS-REFERENCE TO RELATED APPLICATIONS

This application is based upon and claims the benefit of priority from Japanese Patent Application No. 2008-305209, filed Nov. 28, 2008, the entire contents of which are incorporated herein by reference.

### BACKGROUND

1. Field

One embodiment of the invention relates to a video display apparatus and a video display method.

2. Description of the Related Art

In recent years, a plurality of light emitting diodes (LEDs) are often employed as a light source (a backlight) placed behind a liquid crystal display (LCD) device. The LEDs are used as the light source of the backlight because they are suitable for thin and flat LCD devices or to reduce power consumption.

It is known that, in an LCD device provided with such a backlight, the display screen is divided into a plurality of areas and also the backlight comprising LED light sources is divided into a plurality of light source areas each corresponding to one of the areas of the display screen. The luminous or light intensity of the LED light sources is controlled (area-controlled) with respect to each of the areas of the display screen (screen areas).

For example, Japanese Patent Application Publication (KOKAI) No. 2006-147573 discloses a conventional technology for controlling the brightness of a backlight by adjusting the brightness of the light source areas according to the characteristics of an image signal and a signal indicating the illuminance of the surrounding environment detected by a light sensor.

It is also known that, as the directivity of light emitted from the light source of the backlight increases with respect to the display screen, lighting efficiency is improved for the display screen.

For example, Japanese Patent Application Publication (KOKAI) No. 2006-210273 discloses another conventional technology for increasing the directivity of light. With this conventional technology, a waveguide is formed in a space between the light source of the backlight and the display screen. The waveguide is provided with an opening in a triangle or polygonal shape on the light emission side as well as on the light incident side. Thus, the directivity of light emitted from the light source of the backlight increases.

With the conventional technologies described above, area control is not performed in consideration of the shape of the light source areas of the backlight. Therefore, for example, to display a video signal 131 on the display screen as illustrated in FIG. 11, if the brightness is adjusted with respect to each light source area corresponding to the video signal 131, the brightness of the backlight becomes prominent for the video signal 131.

When moving video is displayed on the display screen, a video signal 130 moves, for example, as illustrated in FIGS. 12A, 12B, and 12C along with the lapse of time. Accordingly, light emitted from each light source of the backlight, i.e., the range of light source areas subjected to area control also changes along with the lapse of time as indicated by shaded portions in FIGS. 12A to 12C. Consequently, if a video signal moves, the optical energy of the light source areas changes substantially with the movement of the video signal. This makes the brightness of the backlight more prominent. In other words, the area control is not performed properly.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a liquid crystal display (LCD) device according to a first embodiment of the invention;

FIG. 2 is an exemplary schematic diagram of light source areas into which a backlight is divided for area control in the first embodiment;

FIG. 3 is an exemplary schematic diagram of a light source area and surrounding areas thereof that are emitting light in the first embodiment;

FIG. 4 is an exemplary schematic diagram of a virtual area in which only a light source area is emitting light in the first embodiment;

FIG. 5 is an exemplary schematic diagram for explaining a relationship between light sources that constitute the backlight and the light source areas in the first embodiment;

FIG. 6 is an exemplary schematic diagram for explaining the case where a video signal is displayed on a plurality of light source areas in the first embodiment;

FIGS. 7A to 7C are exemplary schematic diagrams for explaining the case where a video signal moves along with the lapse of time in the first embodiment;

FIG. 8 is an exemplary block diagram of an LCD device according to a second embodiment of the invention;

FIG. 9 is an is an exemplary schematic diagram of light source areas or light source surrounding areas in a honeycomb structure which are divided in the second embodiment;

FIG. 10 is an exemplary schematic diagram for explaining the case where a video signal of a rectangular shape is displayed on an LCD module when the light source areas and the like are horizontally divided in the second embodiment;

FIG. 11 is an exemplary schematic diagram for explaining the case where a video signal is displayed on a display screen according to a conventional technology; and

FIGS. 12A to 12C are exemplary schematic diagrams for explaining the case where a video signal moves along with the lapse of time in the conventional technology.

### DETAILED DESCRIPTION

Various embodiments according to the invention will be described hereinafter with reference to the accompanying drawings. In general, according to one embodiment of the invention, a video display apparatus comprises a display module, a light source device, a video signal input module, a virtual illumination value calculator, a light source illumination value calculator, and a light source controller. The display module is configured to display a video signal. The light source device is configured to be divided into a plurality of light source areas in a honeycomb shape and provided with a plurality of light sources to light up each of the light source areas. The video signal input module is configured to receive the video signal from the outside. The virtual illumination value calculator is configured to calculate an area illumination value indicating the brightness of light source areas to light up based on the video signal received by the video signal input module. The light source illumination value calculator is configured to calculate a light source illumination value to light up each of the light sources based on the area illumination value. The light source controller is configured to light up each of the light sources synchronously with the video signal being displayed on the display module based on the light source illumination value.

According to another embodiment of the invention, there is provided a video display method applied to a video display apparatus comprising a display module configured to display a video signal and a light source device configured to be divided into a plurality of light source areas in a honeycomb shape and provided with a plurality of light sources to light up each of the light source areas. The video display method comprises: a video signal input module receiving the video signal from the outside; a virtual illumination value calculator calculating an area illumination value indicating the brightness of light source areas to light up based on the video signal received by the video signal input module; a light source illumination value calculator calculating a light source illumination value to light up each of the light sources based on the area illumination value; and a light source controller lighting up each of the light sources synchronously with the video signal being displayed on the display module based on the light source illumination value.

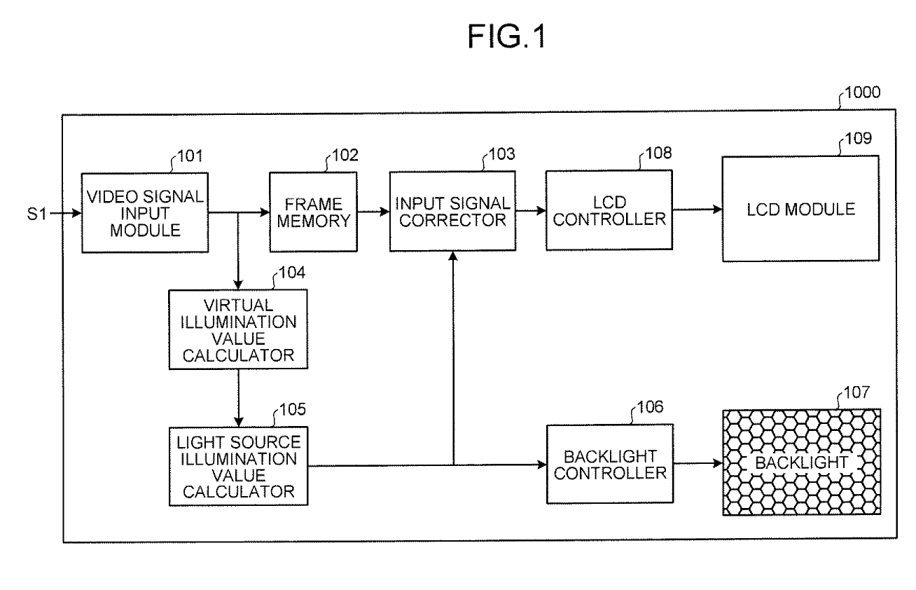

FIG. 1 is a block diagram of a liquid crystal display (LCD) device 1000 according to a first embodiment of the invention. As illustrated in FIG. 1, the LCD device 1000 comprises a video signal input module 101, a frame memory 102, an input signal corrector 103, a virtual illumination value calculator 104, a light source illumination value calculator 105, a backlight controller 106, a backlight 107, an LCD controller 108, and an LCD module 109.

The video signal input module 101 receives a video signal S1 related to video content from the outside. More specifically, the video signal input module 101 receives the video signal S1 from a TV tuner (not illustrated), a network (not illustrated), a storage medium (not illustrated) such as a hard disk drive (HDD) and a digital versatile disk (DVD), and the like, and outputs it to the frame memory 102 and the virtual illumination value calculator 104, which are described later.

The frame memory 102 stores the video signal output from the video signal input module 101 with respect to each frame.

input signal corrector 103 corrects the video signal stored in the frame memory 102. More specifically, the input signal corrector 103 reads the video signal from the frame memory 102, and corrects it based on a light source illumination value output from the light source illumination value calculator 105, which will be described later. The input signal corrector 103 then outputs the corrected video signal to the LCD controller 108, which will be described later.

The virtual illumination value calculator 104 calculates an illumination value to light up the backlight 107 according to the brightness of the video signal output from the video signal input module 101.

More specifically, the virtual illumination value calculator 104 reads the luminance of the video signal output from the video signal input module 101. The virtual illumination value calculator 104 then calculates an illumination value to light up a light source area or a light source surrounding area with luminous or light intensity corresponding to the luminance of the video signal.

The term “light source area” as used herein refers to one of a plurality of areas into which the backlight 107 is divided correspondingly to the LCD module 109. The light source areas are provided with a plurality of light sources that emit light to the LCD module 109. The light sources each emit light according to an illumination value calculated by the light source illumination value calculator 105, which will be described later.

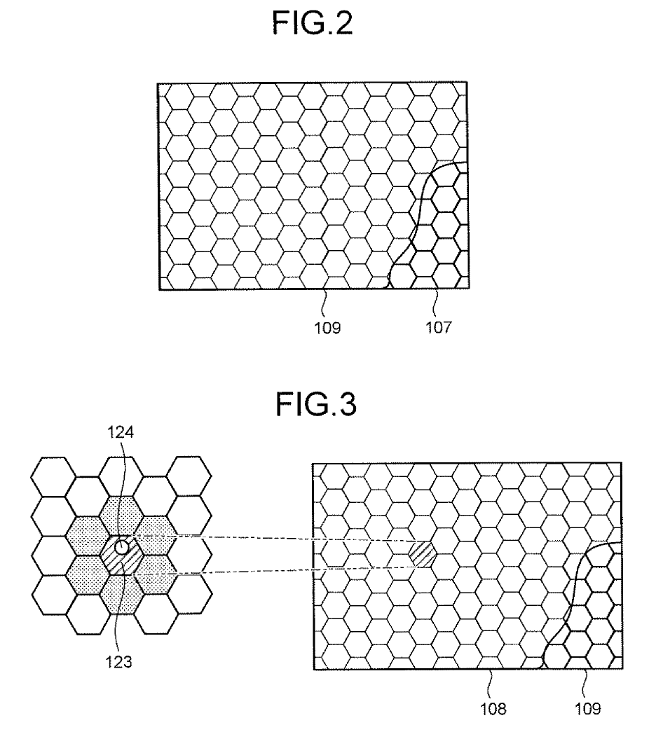

As described above, the backlight 107 is divided into a plurality of light source areas correspondingly to the LCD module 109. To control the light intensity of the backlight 107 with respect to each of the light source areas is herein referred to as “area control”. FIG. 2 is a schematic diagram of the light source areas into which the backlight 107 is divided for the area control.

As illustrated in FIG. 2, the backlight 107 comprises the plurality of light source areas in a honeycomb structure. Incidentally, the term “light source surrounding area” as used herein refers to an area located in the surrounding of a light source area. An area including a light source area and a light source surrounding area will be hereinafter referred to as “virtual area”. Besides, an illumination value to light up the virtual area will be hereinafter referred to as “virtual area illumination value”.

FIG. 3 is a schematic diagram for explaining the case where, when a video signal 124 is displayed at a position on the LCD module 109 corresponding to a light source area 123, the light source area 123 and light source surrounding areas thereof light up. As illustrated in FIG. 31 the virtual illumination value calculator 104 calculates a virtual area illumination value for the light source area 123 and the light source surrounding areas (in the example of FIG. 31 areas surrounding all around the light source area 123) according to the luminance of the video signal 124.

For example, the virtual illumination value calculator 104 determines whether the luminance of the video signal 124 is higher than a predetermined reference value. When determining that the luminance of the video signal 124 is higher than the reference value, the virtual illumination value calculator 104 calculates a virtual area illumination value for the light source area 123 and the light source surrounding areas thereof.

In this manner, the virtual illumination value calculator 104 calculates a virtual area illumination value according to the luminance of the video signal. However, for example, when the luminance of a video signal is lower than the predetermined reference value, the virtual illumination value calculator 104 calculates a virtual area illumination value to light up only the light source area in the virtual area.

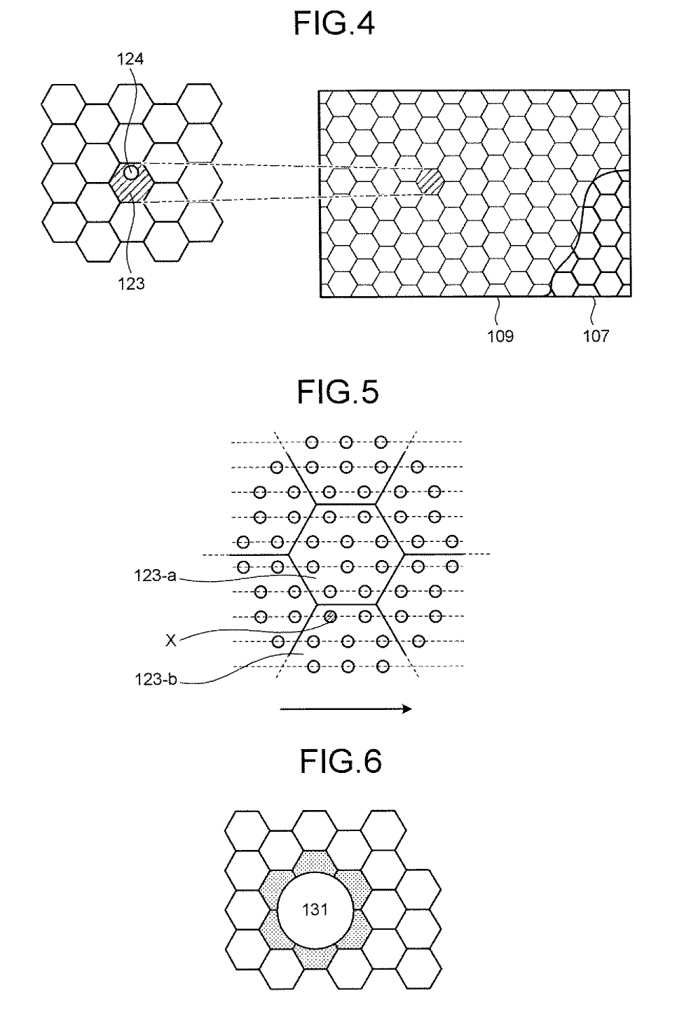

FIG. 4 illustrates the above case where only the light source area 123 lights up in the virtual area. As illustrated in FIG. 4, when the luminance of the video signal 124 is lower than the predetermined reference value, the virtual illumination value calculator 104 calculates a virtual area illumination value to light up only the light source area 123.

The virtual area illumination value maybe calculated in several manners for light source surrounding areas in a virtual area. For example, when the luminance of a video signal, which is located at a position on the LCD module 109 corresponding to a light source area in the virtual area, exceeds the reference value, the luminance value exceeding the reference value may be proportionally divided at a constant rate (for example, according to the distance from the light source area) to the light source surrounding areas or may be equally divided to the light source surrounding areas.

Having calculated the virtual area illumination value, the virtual illumination value calculator 104 outputs the virtual area illumination value and the video signal received from the video signal input module 101 to the light source illumination value calculator 105, which will be described later

Referring back to FIG. 1, a description will be given of the light source illumination value calculator 105.

The light source illumination value calculator 105 calculates a value (hereinafter, “light source illumination value”) to light up each of the light sources of the backlight 107 according to the virtual area illumination value output from the virtual illumination value calculator 104. The light source illumination value calculator 105 outputs the light source illumination value thus calculated and the video signal to the input signal corrector 103 and the backlight controller 106, which will be described later.

For example, as described below, the light source illumination value calculator 105 calculates a light source illumination value to light up each of the light sources at brightness corresponding to a value obtained by dividing the virtual area illumination value calculated by the virtual illumination value calculator 104 by the number of light sources within a light source area (for example, 10 light sources).

The backlight controller 106 outputs the light source illumination value for each of the light sources received from the light source illumination value calculator 105 and an output signal instructing to light up each of the light sources of the backlight 107. With this, each of the light sources of the backlight 107 lights up according to the light source illumination value. The backlight controller 106 lights up each of the light sources synchronously with the timing at which the LCD controller 108, which will be described later, displays the video signal on the LCD module 109.

The backlight 107 emits light to the LCD module 109, which will be described later. As described above, the backlight 107 is provided with the plurality of light sources such as, for example, light emitting diodes (LEDs) for emitting light. The light sources are divided into the plurality of light source areas in a honeycomb structure.

Upon receipt of the output signal from the backlight controller 106, each of the light sources that constitute the backlight 107 emits light according to the light source illumination value. As illustrated in FIG. 2, the backlight 107 is located on the back of the LCD module 109. That is, the backlight 107 is configured as a direct-type backlight that emits light from the back of the LCD module 109.

FIG. 5 is a schematic diagram for explaining a relationship between each of the light sources and the light source areas. As illustrated in FIG. 5, the light sources are arranged in parallel along the direction of scanning lines (the direction indicated by the arrow in FIG. 5). This is because a video signal received from the outside is generally displayed along the direction of the scanning lines indicated by the arrow. Therefore, on the occasion of the area control, this arrangement facilitates a determination as to which light source is included in which light source area, thereby reducing the processing load due to the determination.

More specifically, to light up a light source area of the backlight 107 corresponding to a video signal located at a position X indicated in FIG. 5, it can be understood that not a light source area 123-a but a light source area 123-b needs to be lit up. On the other hand, if the light sources are arranged in a different direction than the scanning lines indicated by the arrow (for example, in the direction perpendicular to that of the scanning lines), it is difficult to determine which of the two, the light source area 123-a or the light source area 123-b, is to be lit up. Incidentally, although each of the light source areas is illustrated by way of example as including 10 light sources in FIG. 5, it may include an arbitrary number of light sources as long as the light sources are arranged in parallel to the direction of the scanning lines.

Referring back to FIG. 1, a description will be given of the LCD controller 108.

The LCD controller 108 controls the transmission of the LCD module 109 according to the video signal corrected and output by the input signal corrector 103. In addition, the LCD controller 108 displays video on the LCD module 109 synchronously with the timing at which the backlight controller 106 lights up each of the light sources of the backlight 107 according to the corrected video signal.

The LCD module 109 is an LCD panel comprising a pair of polarizing plates and a liquid crystal between the polarizing plates. The LCD module 109 displays the video signal, the transmission of which has been controlled by the LCD controller 108.

As described above, according to the first embodiment, the backlight 107 is divided into a plurality of light source areas in a honeycomb structure, and is provided with a plurality of light sources for lighting up each of the light source areas. When the video signal input module 101 receives a video signal, the virtual illumination value calculator 104 calculates a virtual area illumination value according to the luminance of the video signal. Then, the light source illumination value calculator 105 calculates a light source illumination value according to the virtual area illumination value. According to the light source illumination value, the backlight controller 106 lights up each of the light sources synchronously with the timing at which the LCD controller 108 displays the video signal on the LCD module 109. Thus, the difference is reduced between the range of video displayed on the LCD module 109 based on the video signal and the range of light source areas of the backlight 107 lighting up according to the video signal. As a result, it is possible to reduce the prominence of light emitted from the backlight 107.

Incidentally, in the examples of FIGS. 3 and 4, the video signal 124 is smaller than the light source area 123. However, depending on the type of video, there may be a case where a video signal larger than a light source area is displayed on the LCD module 109.

FIG. 6 is a schematic diagram for explaining the case where a video signal is displayed on a plurality of light source areas. As illustrated in FIG. 6, to display the video signal 131 corresponding to a plurality of light source areas on the LCD module 109, light sources are lit up for light source areas (in the example of FIG. 6, seven light source areas) of the backlight 107 corresponding to the position of the video signal 131. Accordingly, light from the backlight 107 is displayed on the LCD module 109 in the state where a difference is caused between the range of the video signal 131 and the range of the light source areas.

However, according to the first embodiment, the light source areas have a honeycomb structure as described above. Therefore, even if light from the backlight 107 is displayed on the LCD module 109, the display range can be smaller than that of the conventional technology illustrated in FIG. 11. Thus, it is possible to reduce the prominence of light from the backlight 107 displayed on the LOD module 109.

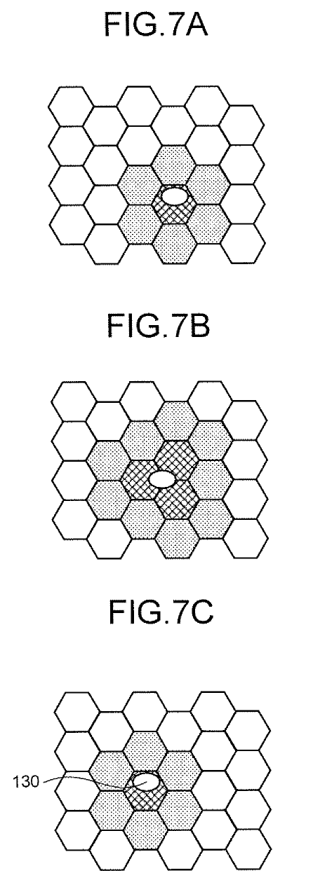

Besides, when the video signal 130 moves as illustrated in FIGS. 7A, 7B, and 7C along with the lapse of time, the range of light source areas subjected to the area control also changes along with the lapse of time as indicated by shaded portions in FIGS. 7A to 7C.

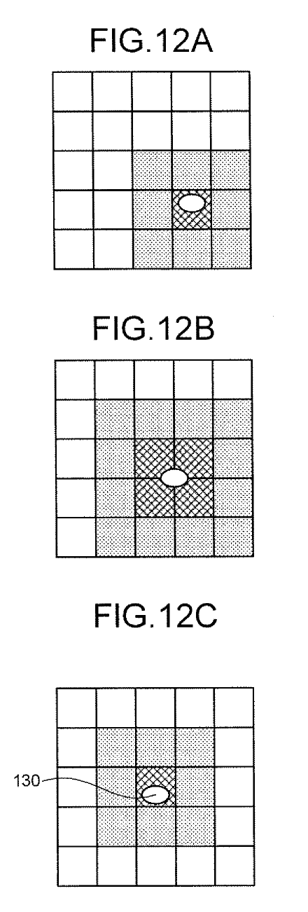

However, according to the first embodiment, the area control is performed such that an illumination value is calculated with respect to each of the light source areas having a honeycomb structure. Therefore, even if a video signal moves, the range of light source areas that light up can be smaller than that of the conventional technology illustrated in FIGS. 12A to 12C. Thus, it is possible to reduce changes in the optical energy of the light source areas due to the movement of the video signal. As a result, it is possible to reduce the prominence of light from the backlight 107 displayed on the LCD module 109.

In the first embodiment described above, the light source areas have a honeycomb structure. The virtual illumination value calculator 104 calculates a virtual area illumination value according to the luminance of a video signal. Then, the light source illumination value calculator 105 calculates a light source illumination value for light source areas according to the virtual area illumination value. Thus, it is made possible to reduce the prominence of light from the backlight 107 displayed on the LCD module 109. However, depending on the type of video, there may be a case where it is preferable to further reduce the prominence of light from the backlight 107. According to a second embodiment of the invention, the light source areas in a honeycomb structure are divided to further reduce the prominence of light from the backlight 107.

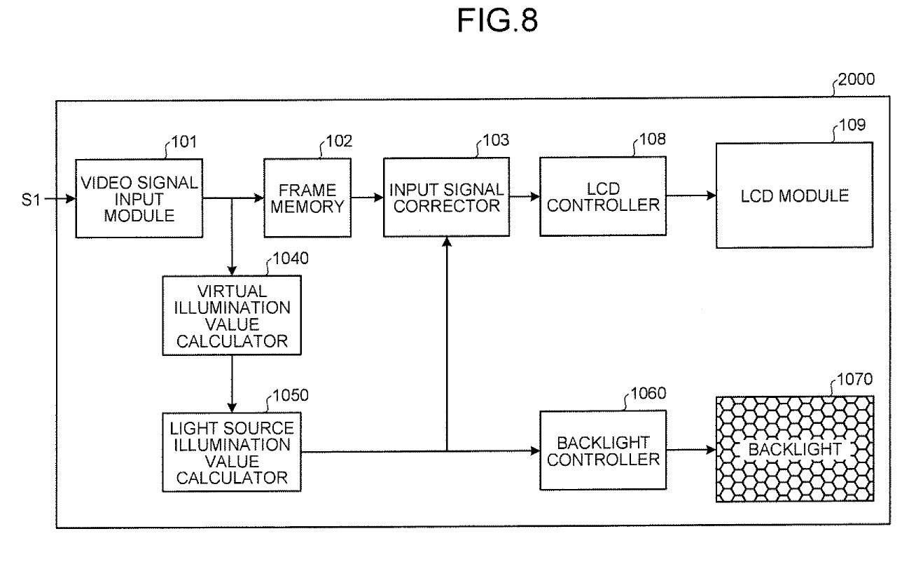

FIG. 8 is a block diagram of an LCD device 2000 according to the second embodiment. Differently from the LCD device 1000 of the first embodiment, the LCD device 2000 of the second embodiment comprises a virtual illumination value calculator 1040, a light source illumination value calculator 1050, a backlight controller 1060, and a backlight 1070, which are different from the virtual illumination value calculator 104, the light source illumination value calculator 105, the backlight controller 106, and the backlight 107 of the first embodiment. Otherwise, the LCD device 2000 is of basically similar configuration and operates in a similar manner to the LCD device 1000. Therefore, the constituent elements corresponding to those of the first embodiment are designated by the same reference numerals, and their description will not be repeated.

In addition to the same process as performed by the virtual illumination value calculator 104 of the first embodiment, the virtual illumination value calculator 1040 reads the luminance of the video signal SI output from the video signal input module 101. The virtual illumination value calculator 1040 then calculates an illumination value (hereinafter, “virtual division area illumination value”) to light up a light source division area or a light source division surrounding area with light intensity corresponding to the Luminance of the video signal S1.

The term “light source division area” as used herein refers to one of areas into which a light source area is divided in predetermined units. The term “light source division surrounding area” as used herein refers to one of areas into which a light source surrounding area is divided in predetermined units. It is assumed that the division units are determined in advance.

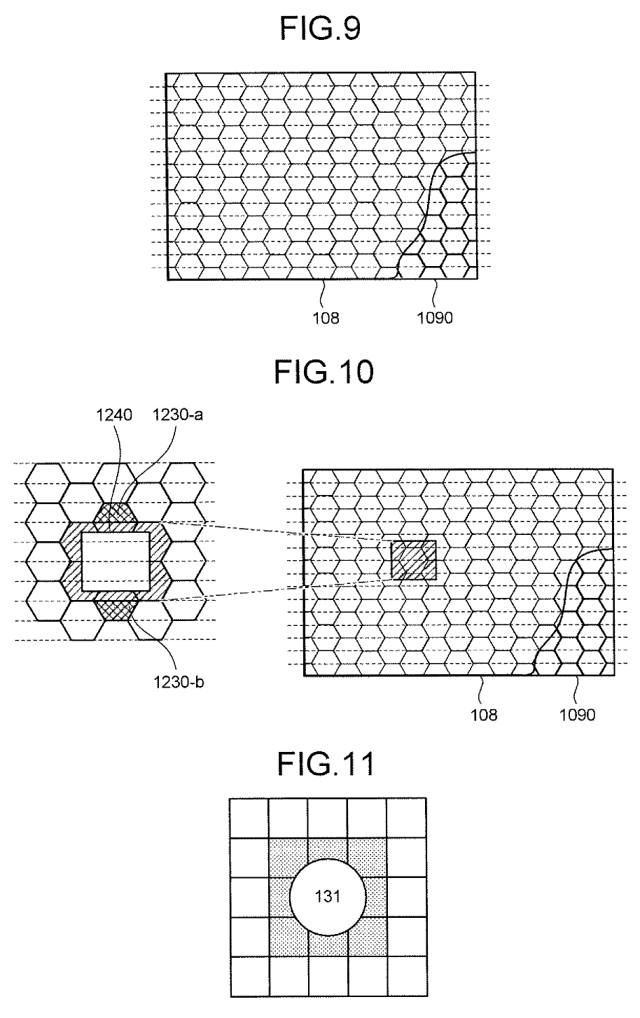

FIG. 9 illustrates an example of the light source division areas and the light source division surrounding areas. As illustrated in FIG. 91 the light source division areas or the light source division surrounding areas are divided by a line passing through the center of the light source areas or the light source surrounding areas and extending parallel to the upper and lower sides of the light source areas or the light source surrounding areas. In other words, each of the light source areas or the light source surrounding areas is horizontally divided into upper and lower light source division areas or light source division surrounding areas. Incidentally, an area including a light source division area and a light source division surrounding area will be hereinafter referred to as virtual division area.

As described above, each of the light source areas and the like is horizontally divided into upper and lower light source division areas and like because, for the same reason as that the light sources are arranged along the direction of the scanning lines in the first embodiment, a video signal is sequentially displayed along the direction of the scanning lines, and also is updated from the upper to lower scanning lines. That is, if each of the light source areas and the like is horizontally divided in the direction of the scanning lines, the area control can be facilitated. Although each of the light source areas and the like is described by way of example as being horizontally divided, it may be divided in any other direction if divided along the direction of the scanning lines.

Besides, although each of the light source areas and the like is described as being divided into a couple of upper and lower light source division areas and like, this is by way of example only. Each of the light source areas and the like may be divided into an arbitrary number of areas as long as it is divided into smaller areas along the direction of the scanning lines so that the area control can be facilitated. For example, if the scanning lines run in the horizontal direction, each of the light source areas and the like is horizontally divided, while if the scanning lines run in the vertical direction, each of the light source areas and the like is vertically divided.

FIG. 10 is a schematic diagram for explaining the case where a video signal 1240 of a rectangular shape is displayed on the LCD module 109 when the light source areas and the like are horizontally divided into upper and lower light source division areas and the like.

As illustrated in FIG. 10, the virtual illumination value calculator 1040 calculates a virtual division area illumination value to light up the virtual division area including a light source division area and light source division surrounding areas thereof of the backlight 1070 according to the luminance of the video signal 1240. At this point, if the light source areas are not divided, the virtual illumination value calculator 1040 calculates an illumination value for a portion including light source division areas 1230-a and 1230-b illustrated in FIG. 10. Consequently, the backlight 1070, which will be described later, lights up light source areas including the light source division areas 1230-a and 1230-b, resulting in the prominence of light from the backlight 107.

However, according to the second embodiment, each of the light source areas is horizontally divided. Accordingly, the virtual illumination value calculator 1040 calculates a virtual division area illumination value to light up a portion (a hatched portion in FIG. 10) not including the light source division areas 1230-a and 1230-b. As a result, the backlight 1070 lights up light source areas not including the light source division areas 1230-a and 1230-b. Thus, it is possible to further reduce the prominence of light emitted from the backlight 107.

Referring back to FIG. 8, a description will be given of the light source illumination value calculator 1050.

In addition to the same process as performed by the light source illumination value calculator 105 of the first embodiment, the light source illumination value calculator 1050 calculates a light source illumination value according to the virtual division area illumination value output from the virtual illumination value calculator 1040. The light source illumination value calculator 1050 outputs the light source illumination value thus calculated and the video signal to the input signal corrector 103 and the backlight controller 1060, which will be described later.

In addition to the same process as performed by the backlight controller 106 of the first embodiment, the backlight controller 1060 outputs the light source illumination value received from the light source illumination value calculator 1050 and an output signal instructing to light up each of the light sources of the backlight 1070. With this, each of the light sources that constitute the backlight 1070 lights up.

As described above, according to the second embodiment, the backlight 1070 is divided into a plurality of light source areas in a honeycomb structure. The backlight 1070 is provided with a plurality of light sources for lighting up each of the light source areas that has opposite sides, among the sides of the light source area, extending along the scanning lines and that is further divided into two areas or more by a straight line parallel to the opposite sides. When the video signal input module 101 receives a video signal, the virtual illumination value calculator 1040 calculates a virtual division area illumination value according to the luminance of the video signal. Then, the light source illumination value calculator 1050 calculates a light source illumination value according to the virtual division area illumination value. According to the light source illumination value, the backlight controller 1060 lights up each of the light sources synchronously with the timing at which the LCD controller 108 displays the video signal on the LCD module 109. Thus, the difference is reduced between the range of video displayed on the LCD module 109 based on the video signal and the range of light source areas of the backlight 1070 lighting up according to the video signal. As a result, it is possible to further reduce the prominence of light emitted from the backlight 1070.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video display apparatus comprising:
a display module configured to display a video signal;
a light source device configured to be divided into a plurality of light source areas in a honeycomb shape and provided with a plurality of light sources to light up each of the light source areas;
a video signal input module configured to receive the video signal from outside;
a virtual illumination value calculator configured to calculate an area illumination value indicating brightness of light source areas to light up based on the video signal received by the video signal input module;
a light source illumination value calculator configured to calculate a light source illumination value to light up each of the light sources based on the area illumination value; and
a light source controller configured to light up each of the light sources synchronously with the video signal being displayed on the display module based on the light source illumination value.

2. The video display apparatus of claim 1, wherein, among sides that constitute each of the light source areas, a pair of opposite sides is configured to extend along scanning lines.

3. The video display apparatus of claim 2, wherein
each of the light source areas is divided into at least two division areas by a straight line parallel to the opposite sides among the sides that constitute each of the light source areas, and
the virtual illumination value calculator is configured to calculate the area illumination value in units of the division areas.

4. The video display apparatus of claim 3, wherein each of the light source areas is divided into an upper division area and a lower division area by the straight line.

5. The video display apparatus of claim 1, wherein the virtual illumination value calculator is configured to determine whether luminance of the video signal is higher than a predetermined value, and, when determining that the luminance of the video signal is higher than the predetermined value, calculate the area illumination value to light up the light source areas including a light source area and surrounding areas surrounding the light source area.

6. The video display apparatus of claim 5, wherein the virtual illumination value calculator is configured to, when determining that the luminance of the video signal is higher than the predetermined value, calculate the area illumination value by proportionally dividing a luminance value exceeding the predetermined value at a predetermined rate to the surrounding areas or by equally dividing the luminance value to the surrounding areas.

7. The video display apparatus of claim 1, further comprising a storage module configured to store the video signal in unit of frame.

8. A video display method applied to a video display apparatus comprising a display module configured to display a video signal and a light source device configured to be divided into a plurality of light source areas in a honeycomb shape and provided with a plurality of light sources to light up each of the light source areas, the video display method comprising:
a video signal input module receiving the video signal from outside;
a virtual illumination value calculator calculating an area illumination value indicating brightness of light source areas to light up based on the video signal received by the video signal input module;
a light source illumination value calculator calculating a light source illumination value to light up each of the light sources based on the area illumination value; and
a light source controller lighting up each of the light sources synchronously with the video signal being displayed on the display module based on the light source illumination value.

9. The video display method of claim 8, wherein
the light source device is configured to be divided into the light source areas each having a pair of opposite sides, among sides that constitute the light source area, extending along scanning lines and divided into at least two division areas by a straight line parallel to the opposite sides, and
the virtual illumination value calculator calculating the area illumination value in units of the division areas.
